(19) United States
(12) Patent Application Publication
(10) Pub. No.: US 2014/0040037 A1
(43) Pub. Date: Feb. 6, 2014

(54) SYSTEM FOR MOBILE CONTENT ADVERTISING AND METHOD FOR MOBILE CONTENT ADVERTISING

(71) Applicants: Ha Young Yoon, Siheung (KR); Taek Kyun Na, Seoul (KR)

(72) Inventors: Ha Young Yoon, Siheung (KR); Taek Kyun Na, Seoul (KR)

(73) Assignee: ITEC TOKYO CORPORATION, Tokyo (JP)

(21) Appl. No.: 14/008,467

(22) PCT Filed: Oct. 25, 2011
(86) PCT No.: PCT/KR2011/007999

§ 371 Date: Oct. 23, 2013

(30) Foreign Application Priority Data
Mar. 28, 2011 (KR) 10-2011-0027509

(51) Int. Cl. G06Q 30/02

(52) U.S. Cl. CPC G06Q 30/0267
USPC 705/14.64

(57) ABSTRACT

Disclosed is a system for providing mobile content which improves the quality of the advertising and promotional content service, and which also improves the efficiency of advertising and promotion. The suggested system includes: a code creating means for creating original content information and a code corresponding to content to be provided; and a terminal for storing the content and the original content information, obtaining at least one content providing means and code which enable the transmission of the corresponding content in response to a received content request message, extracting original content information corresponding to the obtained code and then broadcasting a content request message including the extracted original content information, and receiving corresponding content from at least one content providing means or at least one other terminal.

### TECHNICAL FIELD

The present invention relates to a system for mobile content advertising, and more particularly, to a system for mobile content advertising for improving the quality of an advertising and promotion content service and improving the efficiency of advertising and promotion.

### BACKGROUND ART

In the case of marketing using a quick response (QR) code of which the use has rapidly increased in recent years, an advertising and promotion content publisher publishes a content on a web page and encodes the corresponding web uniform resource locator (URL) to attach the encoded web URL to a newspaper, a product, a vehicle, and the like. A mobile user having a QR-code reader extracts the web URL from the QR code to receive the corresponding content to his/her own terminal from the Internet and reproduce the received content. An advertising and marketing method of a scheme of receiving the content through the Internet has a limit in improving the qualities of advertising and promotion contents by limiting bandwidths of transmission routes up to a content providing device and a final terminal. Further, when a plurality of active QR-code reader requests the same content at the same time, real-time performance when receiving the content is degraded such that the efficiency of advertising and promotion is degraded.

### DISCLOSURE

### Problem to be Solved by the Invention

An object of the present invention is to provide a system for mobile content advertising for improving the quality of an advertising and promotion content service and improving the efficiency of advertising and promotion.

Another object of the present invention is to provide a method for mobile content advertising for improving the quality of an advertising and promotion content service and improving the efficiency of advertising and promotion.

### Technical Solution

In order to achieve the objects, a system for mobile content advertising according to an embodiment of the present invention includes: a code creating means configured to create original content information and a code corresponding to content to be provided; at least one content providing means configured to store the content and the original content information and transmit the corresponding content in response to a received content request message; and a terminal configured to obtain a code, extract original content information corresponding to the obtained code, broadcast a content request message including the extracted original content information, and receive the corresponding content from the at least one content providing means or at least one other terminal.

Herein, the code creating means may include: a content information extracting unit configured to extract basic content information from the provided content, divide the provided content by a predetermined size or time unit, and allocate an original index to each of the divided content parts; an original content information creating unit configured to create the original content information by applying a Hash function to the extracted basic content information; and a code creating unit configured to create a code by using the created original content information.

Herein, the basic content information may include at least one of a content publisher ID, a content size, a content name, a business type of the content publisher, a business condition of the content publisher, a type of a coupon, and a uniform resource locator (URL).

Herein, the content providing means may include: a content providing control unit configured to judge, when obtaining the content request message from the terminal, whether a content corresponding to the obtained content request message is present, transmit a content receiving agreement confirmation message to the terminal when the corresponding content is present, and perform control for transmitting the corresponding content when receiving a content receiving agreement message from the terminal; a first content communication unit configured to perform communication with the terminal based on the control by the content providing control unit; and a content managing unit configured to store the content provided from the code creating means and the original content information corresponding thereto.

Herein, the terminal receives an advertising content from the at least one content providing means or at least one other terminal under a distributed environment, and receives a coupon from a content server by using a URL extracted from the obtained code.

The terminal selects, when broadcasting the content request message including the extracted original content information and then obtaining a plurality of content receiving agreement confirmation messages from the at least one content providing means or the at least one other terminal, a device, which is to receive the content, of the at least one content providing means or the at least one other terminal based on a predetermined reference, transmits the content receiving agreement message to the selected device, and then receives the corresponding content from the device.

The terminal selects, when receiving of the corresponding content is stopped during receiving the corresponding content from the device, another device that is able to subsequently receive the corresponding content and provides the selected another device with original index information corresponding to a location where or a time when the corresponding content is to be subsequently received to subsequently receive the corresponding content from the selected another device.

The terminal provides the original index information corresponding to the location where or the time when the corresponding content is to be subsequently received by accessing the content server by using the URL extracted from the obtained code and then subsequently receives the corresponding content from the content server, when receiving of the corresponding content is stopped during receiving of the corresponding content from the device and there is no device that is to subsequently receive the corresponding content.

The terminal receives the corresponding content by accessing the content server by using the URL extracted from the obtained code when the content receiving agreement confirmation message is not received within a predetermined time.

The terminal stops receiving the corresponding content and selects a device, which is to receive the corresponding content, between at least one content providing means and at least one other terminal and then provides the selected device with the original index information corresponding to the location where or the time when the corresponding content is to be subsequently received to subsequently receive the corresponding content, when receiving the content receiving agreement confirmation message from the at least one content providing means or the at least one other terminal during receiving the corresponding content by accessing the content server by using the extracted URL.

The terminal provides the content receiving agreement confirmation message to the at least one other terminal when receiving the content request message for a previously received content from the at least one other terminal and transmits, when receiving the content receiving agreement message from a specific terminal of the at least one other terminal, the previously received content to the specific terminal.

The terminal provides the content receiving agreement confirmation message to the at least one other terminal when receiving the content request message for a previously received content from the at least one other terminal and transmits, when receiving the content receiving agreement message from a specific terminal of the at least one other terminal, the previously received content to the specific terminal, according to any one of a user's selection and a user's change of set-up of the terminal.

In order to achieve another object of the present invention, A method for mobile content advertising according to an embodiment of the present invention includes: code creating means, at least one content providing means, a terminal, and at least one other terminal, the method comprising: creating, by the code creating means, original content information and a code corresponding to content to be provided; storing, by the at least one content providing means, the content and the original content information and transmitting the corresponding content to the terminal in response to a content request message received from the terminal; and obtaining, by the terminal, a code, extracting original content information corresponding to the obtained code, broadcasting a content request message including the extracted original content information, and receiving the corresponding content from the at least one content providing means or the at least one other terminal.

Herein, the creating of, by the code creating means, original content information and a code corresponding to content to be provided includes: extracting, by the code creating means, basic content information from the provided content, dividing the provided content by a predetermined size or time unit, and allocating an original index to each of the divided content parts; creating, by the code creating means, the original content information by applying a Hash function to the extracted basic content information; and creating, by the code creating means, a code by using the created original content information.

The transmitting of the corresponding content in response to the received content request message includes: judging, by the at least one content providing means, when obtaining the content request message from the terminal, whether a content corresponding to the obtained content request message is present and transmitting a content receiving agreement confirmation message to the terminal when the corresponding content is present; and reading, by the at least one content providing means, a content corresponding to the content request message and transmitting the read content to the terminal when receiving a content receiving agreement message from the terminal.

In the receiving of the corresponding content, the terminal receives an advertising content from the at least one content providing means or the at least one other terminal under a distributed environment, and receives a coupon by accessing a content server by using a URL extracted from the obtained code.

The receiving of the corresponding content includes: broadcasting, by the terminal, the content request message including the extracted original content information; selecting, by the terminal, a device, which is to receive the corresponding content, of the at least one content providing means or the at least one other terminal, based on a predetermined reference, when obtaining a plurality of content receiving agreement confirmation messages from the at least one content providing means or the at least one other terminal; and transmitting, by the terminal, the content receiving agreement message to the selected device to receive the corresponding content from the selected device.

In the receiving of the corresponding content, when receiving of the corresponding content is stopped during receiving the corresponding content from the device, another device that is able to subsequently receive the corresponding content is selected and original index information corresponding to a location where or a time when the corresponding content is to be subsequently received is provided to the selected another device to subsequently receive the corresponding content from the selected another device.

In the receiving of the corresponding content, the original index information corresponding to the location where or the time when the corresponding content is to be subsequently received is provided by accessing the content server by using the URL extracted from the obtained code and then the corresponding content is subsequently received from the content server, when receiving of the corresponding content is stopped during receiving the corresponding content from the device and there is no device that is to subsequently receive the corresponding content.

In the receiving of the corresponding content, the terminal receives the corresponding content by accessing the content server by using the URL extracted from the obtained code when the content receiving agreement confirmation message is not received within a predetermined time.

In the receiving of the corresponding content, the receiving of the corresponding content is stopped and the device that is to receive the corresponding content is selected between the at least one content providing means and the at least one other terminal and then the original index information corresponding to the location where or the time when the corresponding content is to be subsequently received is provided to the selected device to subsequently receive the corresponding content, when receiving the content receiving agreement confirmation message from the at least one content providing means or the at least one other terminal during receiving the corresponding content by accessing the content server by using the extracted URL.

The receiving of the corresponding content includes providing the content receiving agreement confirmation message to the at least one other terminal when receiving the content request message for a previously received content from the at least one other terminal and transmitting, when receiving the content receiving agreement message from a specific terminal of the at least one other terminal, the previously received content to the specific terminal.

The receiving of the corresponding content includes providing the content receiving agreement confirmation message to the at least one other terminal when receiving the content request message for a previously received content from the at least one other terminal and transmitting, when receiving the content receiving agreement message from a specific terminal of the at least one other terminal, the previously received content to the specific terminal, according to any one of a user's selection and a user's change of set-up of the terminal.

### Effects of the Invention

According to embodiments of the present invention, a system for providing a mobile content may obtain a code, broadcast a content request message including original content information extracted from the obtained code, and receive the corresponding content from at least one content providing means or at least one other terminal under a distributed environment.

Therefore, the quality of an advertising and promotion content service can be improved and real-time performance of receiving a content when a plurality of contents is requested at the same time is improved, thereby increasing the efficiency of advertising and promotion.

### BRIEF DESCRIPTION OF DRAWINGS

FIG. 1 illustrates a configuration of a system for mobile content advertising according to an embodiment of the present invention.

FIG. 2 is a block diagram illustrating a more detailed configuration of the system for mobile content advertising according to the embodiment of the present invention which is illustrated in FIG. 1.

FIG. 3 is a flowchart illustrating a method for mobile content advertising according to an embodiment of the present invention.

FIG. 4 is a flowchart illustrating an operation performed in a code creating means in the method for mobile content advertising according to the embodiment of the present invention.

FIG. 5 is a flowchart illustrating an operation performed by a terminal in the method for mobile content advertising according to the embodiment of the present invention.

FIG. 6 illustrates an experimental environment for evaluating performance of the method for mobile content advertising according to the embodiment of the present invention.

FIGS. 7a to 7c illustrate results of evaluating performance of the method for mobile content advertising according to the embodiment of the present invention.

### MODE FOR INVENTION

The present invention may have various modifications and various embodiments and specific embodiments will be illustrated in the drawings and described in detail in the detailed description.

However, this does not limit the present invention within specific embodiments, and it should be understood that the present invention covers all the modifications, equivalents and replacements within the idea and technical scope of the present invention.

Terminologies such as first or second may be used to describe various components but the components are not limited by the above terminologies. The above terminologies are used only to discriminate one component from the other component. For example, without departing from the scope of the present invention, a first component may be referred to as a second component, and similarly, a second component may be referred to as a first component. Terms such as and/or include a combination of a plurality of related items or any item of the plurality of related items.

It should be understood that, when it is described that an element is “coupled” or “connected” to another element, the element may be “directly coupled” or “directly connected” to the another element or “coupled” or “connected” to the another element through a third element. In contrast, it should be understood that, when it is described that an element is “directly coupled” or “directly connected” to another element, it is understood that no element is not present between the element and the another element.

Terms used in the present application are used only to describe specific embodiments, and are not intended to limit the present invention. A singular form may include a plural form if there is no clearly opposite meaning in the context. In the present invention, it should be understood that term “include” or “have” indicates that a feature, a number, a step, an operation, a component, a part or the combination those of described in the specification is present, but does not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms defined in generally used dictionary shall be construed that they have meanings matching those in the context of a related art, and shall not be construed in ideal or excessively formal meanings unless they are clearly defined in the present application.

Hereinafter, an embodiment of the present invention will be described in detail with reference to the accompanying drawings. In describing the present invention, the same reference numeral refers to the same component in the drawing for easy general understanding and the same component will not be duplicativley described.

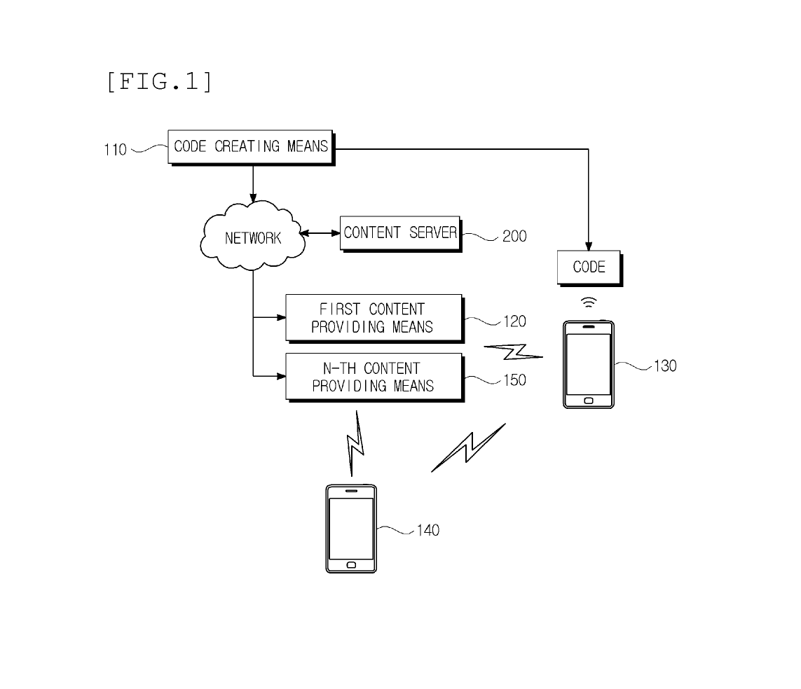

FIG. 1 illustrates a configuration of a system for mobile content advertising according to an embodiment of the present invention.

Referring to FIG. 1, a system for mobile content advertising according to an embodiment of the present invention may include a code creating means 110, a first content providing means 120, a first user terminal 130, a second user terminal 140, an n-th content providing means 150, and a content server 200.

The code creating means 110 obtains a content from a content publisher, creates original content information corresponding to the obtained content, and creates a code to originally identify the content by using the created original content information.

Further, the code creating means 110 may divide the obtained content by a predetermined size or time unit and allocate an original index to each of the divided content parts. Information on the allocated original index is included in the original content information of the corresponding content to be used when a user terminal performs take-over.

Herein, the content may include an advertising content and/or a coupon. Further, the code may be configured by N-dimensional images such as a bar code and a dot code. Herein, N is a natural number of 1 or more. Further, the created code may be attached to a predetermined device or displayed at a predetermined location so as for a user to perform photographing or scanning. In addition, the created code may be printed on media such as a newspaper and a magazine.

Moreover, the code creating means 110 may provide contents and original content information corresponding to each of the contents to the content server 200 connected with a network and a plurality of user terminals accesses the content server 200 by using a URL to receive the corresponding content.

The first content providing means 120 is connected with the code creating means 110 through a wired or wireless network, and obtains and stores the contents and the original content information from the code creating means 110.

Further, when the first content providing means 120 receives a content request message from at least one user terminal, the first content providing means 120 transmits a content receiving agreement confirmation message to the corresponding user terminal, and when the first content providing means 120 obtains a request content receiving agreement message from the corresponding user terminal, the first content providing means 120 reads a request content and transmits the read request content to the corresponding user terminal.

Herein, the system for mobile content advertising includes a plurality of content providing means 120 such that each of the content providing means may transmit the corresponding content receiving agreement confirmation message to the user terminal that requests the content.

Since the n-th content providing means 150 has the same configuration as the first content providing means 120 and each component of the n-th content providing means 150 performs the same function as the corresponding component of the first content providing means 120, a detailed description will be omitted in order to avoid duplication.

The first user terminal 130 or the second user terminal 140 obtains the code and extracts the original content information from the obtained code. The first user terminal 130 or the second user terminal 140 inserts the extracted original content information into a content request message and broadcasts the inserted original content information.

Then, when the first user terminal 130 or the second user terminal 140 obtains a plurality of content receiving agreement confirmation messages from at least one content providing means or at least one other terminal under a distributed environment, the first user terminal 130 or the second user terminal 140 selects a device, which will receive a content, in the at least one content providing means or the at least one other terminal based on a predetermined reference and receives the corresponding content from the device by transmitting the content receiving agreement message to the selected device.

Herein, the predetermined reference may include, for example, the intensity, a transmission speed, and the like of a signal received from at least one content providing means or at least one other terminal.

Herein, the first user terminal 130 and the second user terminal 140 are connected with each other through a wired or wireless interface and have the same function.

In detail, when the first user terminal 130 broadcasts the content request message, the second user terminal 140 under the distributed environment may transmit the content receiving agreement confirmation message to the first user terminal 130 as a response thereto and the first user terminal 130 that receives the content receiving agreement confirmation message from the second user terminal 140 transmits the content receiving agreement message to the second user terminal 140 so as to receive the request content from the second user terminal 140.

Alternatively, when the second user terminal 140 broadcasts the content request message, the first user terminal 130 under the distributed environment may transmit the content receiving agreement confirmation message to the second user terminal 140 as a response thereto and the second user terminal 140 that receives the content receiving agreement confirmation message from the first user terminal 130 transmits the content receiving agreement message to the first user terminal 130 so as to receive the request content from the first user terminal 130.

Herein, communication between the user terminals or communication between the content providing means and the user terminal may be performed by using various radio communication technologies such as 802.11x (for example, 802.11a, 802.11b, 802.11g, 802.11n, 802.11ac, etc.), Bluetooth, Zigbee, ultra-wide band (UWB) communication, and binary code division multiple access (B-CDMA).

The content server 200 is connected to the network, and receives the contents including the advertising content and/or coupon from the content publisher and stores the received contents. Further, the content server 200 may be configured to provide the contents when the plurality of user terminals and/or the plurality of content providing means access the content server 200 by using the URL to request the contents.

When the content publisher centrally manages a total quantity of the coupons in FIG. 1, the content publisher may provide the advertising content and/or coupon to the content server 200 and the advertising content to the code creating means 110. Therefore, the first user terminal 130 may receive the advertising content from at least one content providing means or at least one other terminal under the distributed environment, and receive the coupon from the content server 200.

In detail, the code creating means 110 obtains the advertising content from the content publisher, creates a URL to receive original content information and a coupon corresponding to the obtained advertising content, and thereafter, creates a code including the URL to receive the created original content information and coupon.

Further, the code creating means 110 may provide the original content information corresponding to the advertising content to the content server 200.

Meanwhile, the first user terminal 130 may obtain the code to extract a URL to receive original content information and a coupon regarding the advertising content from the obtained code, and thereafter, insert the original content information into the advertising content request message and broadcast the message inserted with the original content information, select a device, which will receive the advertising content, from at least one content providing means or at least one other terminal, and receive the corresponding advertising content from the selected device. Further, the first user terminal 130 may receive the coupon by accessing the content server 200 by using a URL to receive the coupon according to a user operating control signal.

Herein, the content server 200 may obtain the advertising content and the coupon from the advertising publisher and transmit the coupon when the first user terminal requests the coupon by accessing the corresponding server by using the URL.

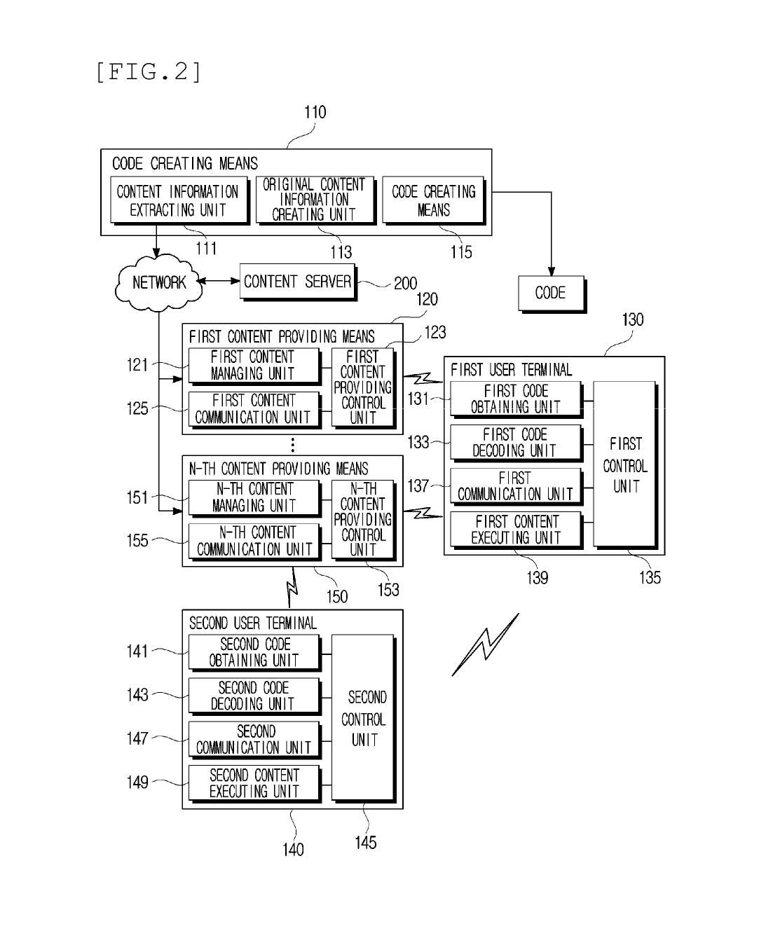

FIG. 2 is a block diagram illustrating a more detailed configuration of the system for mobile content advertising according to the embodiment of the present invention illustrated in FIG. 1.

Referring to FIG. 2, the system for mobile content advertising according to the embodiment of the present invention may include a code creating means 110, a first content providing means 120, a first user terminal 130, a second user terminal 140, an n-th content providing means 150, and a content server 200.

The code creating means 110 may include a content information extracting unit 111, an original content information creating unit 113, and a code creating unit 115.

The content information extracting unit 111 extracts basic content information from the content obtained from the content publisher.

Herein, the content may include an advertising content and/or a coupon. Further, herein, the basic content information includes, for example, a content publisher ID, a content size, a content name, a business type of the content publisher, a business condition of the content publisher, a type of a coupon, and a uniform resource locator (URL). The content information extracting unit 111 provides the extracted basic content information to the original content information creating unit 113.

Further, the content information extracting unit 111 divides the obtained content by a predetermined size or time unit and allocates an original index to each of the divided content parts. For example, when a whole size of a predetermined content is 10 Mbytes, the content information extracting unit 111 may divide 10 Mbytes by the unit of 1 Mbyte and thereafter, allocate original indexes of Nos. 1 to 10 to the respective divided units.

The original content information creating unit 113 may create a series of bitstreams (original content information) by using a Hash function with respect to the obtained basic content information.

In this case, the length of the Hash is variable and is large enough to originally identify the content. Further, a series of bitstreams (original content information) may be created by using a standard method such as a message-digest algorithm 5 (MD-5).

The original content information creating unit 113 may provide the created bitstream (original content information) to the code creating unit 115 and the content providing means 120. Further, the original content information creating unit 113 may provide contents and original content information corresponding to each of the contents to the content server 200 connected with the network.

The code creating unit 115 creates a code by using the original content information provided from the original content information creating unit 113.

Herein, the code may be configured by N-dimensional images such as a bar code and a dot code. Herein, N is a natural number of 1 or more. Further, the created code may be attached to a predetermined device or displayed at a predetermined location so as for a user to perform photographing or scanning. In addition, the created code may be printed on media such as a newspaper and a magazine.

The first content providing means 120 may include a first content managing unit 121, a first content providing control unit 123, and a first content communication unit 125.

The first content managing unit 121 obtains and stores the content and the original content information from the code creating means 110. In FIG. 2, it is illustrated that the content and the original content information are obtained through the network, but it should be understood that the obtaining method is not limited thereto.

When the first content providing control unit 123 obtains a content request message from the first content communication unit 125, the first content providing control unit 123 encodes the obtained content request message to judge whether a request content is present in the first content managing unit 121.

When the first content providing control unit 123 judges that the request content is present in the first content managing unit 121, the first content providing control unit 123 creates a content receiving agreement confirmation message and provides the created message to the first content communication unit 125. Thereafter, when the first content providing control unit 123 obtains a content receiving agreement message from the first content communication unit 125, the first content providing control unit 123 reads the request content from the first content managing unit 121 and provides the read content to the first content communication unit 125.

When the first providing control unit 121 judges that the request content is not present in the first content managing unit 121, the first content providing control unit 123 does not respond to the content request message.

The first content communication unit 125 receives the content request message and provides the received content request message to the first content providing control unit 123. Further, the first content communication unit 125 transmits the content receiving agreement confirmation message obtained from the first content providing control unit 125 to a terminal that requests the content. Herein, the content receiving agreement confirmation message may be transmitted by a unicast scheme.

Further, when the first content communication unit 125 receives the content from the first content providing control unit 123, the first content communication unit 125 transmits the received content to the terminal that requests the content.

Since the n-th content providing means 150 has the same configuration as the first content providing means 120 and each component of the n-th content providing means 150 performs the same function as the corresponding component of the first content providing means 120, a detailed description will be omitted in order to avoid duplication.

The first user terminal 130 includes a first code obtaining unit 131, a first code decoding unit 133, a first control unit 135, a first communication unit 137, and a first content executing unit 139.

A mobile content transmitting/receiving terminal included in a whole system of the present invention may include, for example, a portable terminal (for example, a smart phone, a PDA, or a PMP) incorporated with a camera, a PC connected with the camera, a camera incorporated tablet PC, a camera incorporated notebook, a goggle connected with the camera, and the like.

First, the first code obtaining unit 131 includes a camera (not illustrated) that is capable of obtaining a code, and photographs the code by means of the provided camera and thereafter, provides the obtained code to the first code decoding unit 133. Herein, it should be understood that the camera is presented as a representative example of all devices capable of optically recognizing a code.

The first code decoding unit 133 extracts original content information and URL information corresponding to the provided code by decoding the code provided from the first code obtaining unit 131, and provides the extracted original content information and URL information to the first control unit 135. Herein, the original content information may include original index information allocated to each part of the content.

The first control unit 135 inserts the original content information obtained from the first code decoding unit 133 into the content request message and provides the message inserted with the original content information message to the first communication unit 137. Further, when the first control unit 135 obtains the content receiving agreement confirmation message from the first communication unit 137, the first control unit 135 creates the content receiving agreement message and provides the created message to the first communication unit 137.

Herein, when the first control unit 135 obtains a plurality of content receiving agreement confirmation messages from at least one content providing means or at least one other terminal through the first communication unit 137, the first control unit 135 extracts information on the content providing means from the plurality of obtained content receiving agreement confirmation messages, selects a device, which will receive the content, based on a predetermined reference, creates the content receiving agreement message with the selected device, and provides the created message to the first communication unit 137.

Herein, the predetermined reference may include, for example, the intensity, a transmission speed, and the like of a signal received from at least one content providing means or at least one other terminal.

The first communication unit 137 broadcasts the content request message obtained from the first control unit 135. Thereafter, the first communication unit 137 receives a request content receiving agreement confirmation message from at least one content providing means or at least one other terminal and provides the received message to the first control unit 135.

The first communication unit 137 broadcasts the content request message until the content is completely received based on control by the first control unit 135, activates a timer for a predetermined time, and thereafter, waits to receive the content receiving agreement confirmation message from at least one content providing means or at least one other user terminal.

Herein, when the first communication unit 137 fails to receive the content receiving agreement confirmation message for the time, the first communication unit 137 may receive the content after accessing the content server 200 by using the stored URL based on the control by the first control unit 135.

The first communication unit 137 continuously broadcasts the content request message based on the control by the first control unit 135 even during receiving the content by accessing the content server 200 by using the stored URL.

Therefore, when the first communication unit 137 receives the content receiving agreement confirmation message from at least one content providing means or at least one other terminal during receiving the content from the content server 200 based on the control by the first control unit 135, the first communication unit 137 stops receiving the received content by accessing the content server 200 by using the URL based on the control by the first control unit 135, selects a device that will receive the content, and thereafter, the selected device may subsequently receive the content from a part wherein receiving is stopped.

Herein, in subsequently receiving the content from the part where receiving is stopped, for example, the device that will receive the content may subsequently receive the content from the part that stops being received while receiving the content by providing original index information corresponding to a location where or a time when the content will be subsequently received to the device that will receive the content.

Herein, since a speed of receiving the content from the selected device is higher than a speed of receiving the content from the content server 200, content receiving performance may be improved by stopping receiving the content from the content server 200 and subsequently receiving the content by the selected device.

Further, the first communication unit 137 transmits the content receiving agreement message obtained from the first control unit 135 to the selected device, and receives the request content from the selected device and provides the received content to the first content executing unit 139.

Herein, when receiving the content from the device is stopped, the first communication unit 137 accesses the content server 200 by using the stored URL based on the control by the first control unit 135 and thereafter, provides the content server 200 with the original index information corresponding to the location where or the time when the content will be subsequently received, thereby subsequently receiving the content from the part that stops being received during receiving the content from the content server 200.

The first content executing unit 139 performs a function to execute the received content in response to an operation control signal received from the first control unit 135.

Herein, the first content executing unit 139 may include an audio and/or video codec corresponding to an encoded format in order to execute an adverting music, an advertising moving picture, a document, and the like which are encoded to a predetermined format and provide a video and/or audio signal corresponding to the executed content to a display device and/or an audio device.

The second user terminal 140 includes a second code obtaining unit 141, a second code decoding unit 143, a second control unit 145, a second communication unit 147, and a second content executing unit 149. Since each component of the second user terminal 140 performs the same function as each component of the first user terminal 130, a description thereof will be omitted.

In the system for mobile content advertising according to the embodiment of the present invention, which is illustrated in FIG. 2, the first user terminal 130 receives the content from a predetermined content providing means as an example, but in another embodiment of the present invention, when the first user terminal 130 receives a content request message for a previously received content, the first user terminal 130 may transmit a content corresponding to the content request message to a terminal that transmits the content request message. Further, in yet another embodiment of the present invention, according to any one of a user selection and a user's change of set-up of the first user terminal 130, when the first user terminal 130 receives the content request message for the previously received content, the first user terminal 130 may transmit the content corresponding to the content request message to the terminal that transmits the content request message.

Herein, communication between the user terminals or communication between the content providing means and the user terminal may be performed by using various radio communication technologies such as 802.11x (for example, 802.11a, 802.11b, 802.11g, 802.11n, 802.11ac etc.), Bluetooth, Zigbee, ultra-wide band (UWB) communication, and binary code division multiple access (B-CDMA).

The content server 200 is connected to the network, and receives the contents including the advertising and/or coupon from the content publisher and stores the received contents. Further, the content server 200 may be configured to extract and provide the contents when the plurality of user terminals and/or the plurality of content providing means access the content server 200 by using the URL to request the contents. When the content server 200 receives the original index information corresponding to the location where or the time when the content will be subsequently received from the plurality of user terminals and/or the plurality of content providing means, the content server 200 may provide the contents from the part corresponding to the original index information.

In the system for mobile content advertising according to the embodiment of the present invention, when the content stops being received, it is described that the content is subsequently received from the part where receiving the content is stopped by accessing the content server by using the stored URL, but in another embodiment of the present invention, when the content stops being received, the device that will receives the content is selected by receiving the content receiving confirmation message from at least one content providing means or at least one other terminal before subsequently receiving the content from the part where receiving the content from the content server is stopped by using the URL. Thereafter, the content is received from the part where receiving the content is stopped during receiving the content from the selected device by providing the selected device with the original index information corresponding to the location where or the time when the content will be subsequently received, and if there is no device that will subsequently receive the content, the content may be received from the part where receiving the content is stopped, from the content server by using the URL.

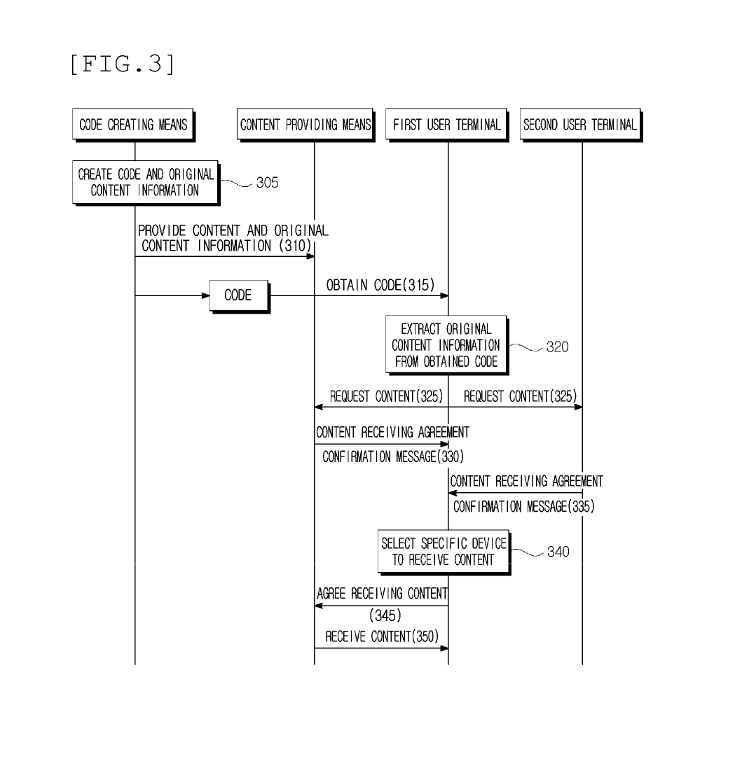

FIG. 3 is a flowchart illustrating a method for mobile content advertising according to an embodiment of the present invention.

Referring to FIG. 3, a code creating means creates original content information by obtaining a content from a content publisher and thereafter creates a code to originally identify the content by using the created original content information (step 305) and provides the obtained content and the created original content information to a content providing means (step 310).

Herein, the code may be configured by a 2D image or an N-dimensional image such as a bar code and a dot code. Further, the created code may be attached to a predetermined device or displayed at a predetermined location so as for a user to perform photographing or scanning.

In addition, the created code may be printed on media such as a newspaper and a magazine.

A first user terminal obtains a code from a printing matter printed with the code (step 315) and extracts original content information, URL information, and the like from the obtained code (step 320). The first user terminal inserts the extracted original content information into a content request message and broadcasts the message inserted with the original content information (step 325). Herein, the original content information may include original index information allocated to each part of the content.

The content providing means receiving the content request message from the first user terminal and a second user terminal transmit a content receiving agreement confirmation message by a unicast scheme when there is the corresponding content (steps 330 and 335).

The first user terminal extracts information on the content providing means and the second user terminal from a plurality of received content receiving agreement confirmation messages and selects a device, which will receive the corresponding content, between the content providing means and the second user terminal based on a predetermined reference (step 340).

Herein, the predetermined reference may include, for example, the intensity, a transmission speed, and the like of a signal received from at least one content providing means or at least one other terminal.

The first user terminal transmits a content receiving agreement message to the content providing means selected as a place, which will receive the content, by the unicast scheme (step 345).

The content providing means that receives the content receiving agreement message from the first user terminal transmits the corresponding content to the first user terminal (step 350).

In the method for mobile content advertising according to the embodiment of the present invention illustrated in FIG. 3, a first content providing means, an n-th content providing means, and the second user terminal are exemplified as a device that may transmit the content and the first user terminal is exemplified as a device that may receive the content, for convenience of description, but in another embodiment of the present invention, it should be understood that at least one terminal other than the first user terminal and the second user terminal may be present. Further, the terminal other than the first user terminal and the second user terminal may perform the same functions as the functions of the first user terminal and the second user terminal described in FIG. 3.

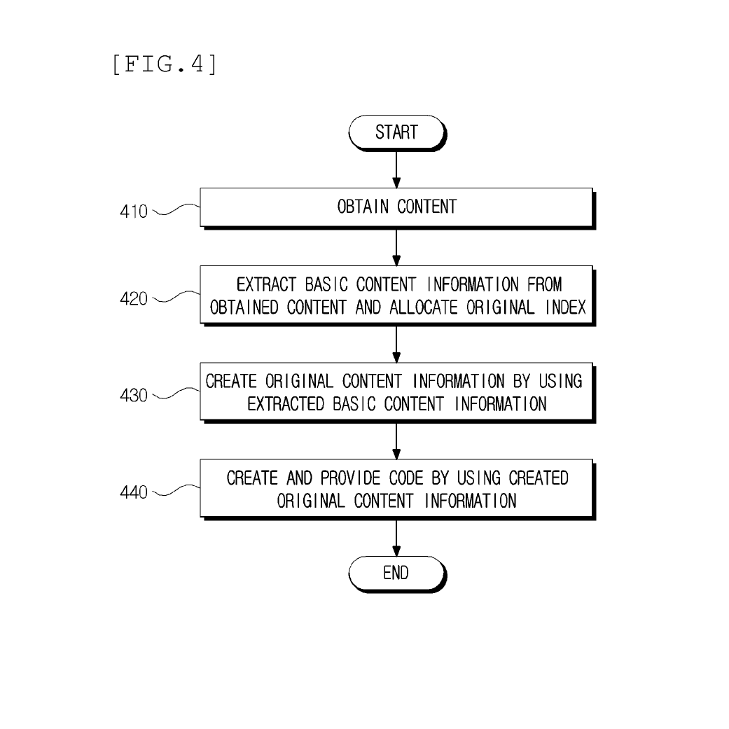

FIG. 4 is a flowchart illustrating an operation performed in a code creating means in the method for mobile content advertising according to the embodiment of the present invention.

Referring to FIG. 4, the code creating means obtains the content from the content publisher and provides the obtained content (step 410). The content may include an advertisement, a coupon, and the like.

The code creating means divides the obtained content by a predetermined size or time unit, and allocates an original index to each of the divided content parts, extracts basic content information, and provides the extracted basic content information (step 420).

Herein, in allocating the original index to each of the divided content parts, for example, when the size of a predetermined content is 10 Mbytes, the code creating means divides 10 Mbytes by the unit of 1 Mbyte and thereafter, may allocate original indexes of Nos. 1 to 10 to the respective divided contents.

Herein, the basic content information includes, for example, a content publisher ID, a content size, a content name, a business type of the content publisher, a business condition of the content publisher, a type of a coupon, and a URL.

The code creating means creates a series of bitstreams (original content information) by using a Hash function with respect to the basic content information obtained in step 420 and provides the created bitstreams (original content information) (step 430).

In this case, the length of the Hash is variable and is large enough to originally identify the content. Further, a series of bitstreams (original content information) may be created by using a standard method such as a message-digest algorithm 5 (MD-5).

The code creating means obtains the original content information provided in step 430, and creates a code by using the obtained original content information and provides the created code (step 430).

Herein, the code may be configured by N-dimensional images such as a bar code and a dot code. Herein, N is a natural number of 1 or more. Further, the created code may be attached to a predetermined device or displayed at a predetermined location so as for a user to perform photographing or scanning. In addition, the created code may be printed on media such as a newspaper and a magazine.

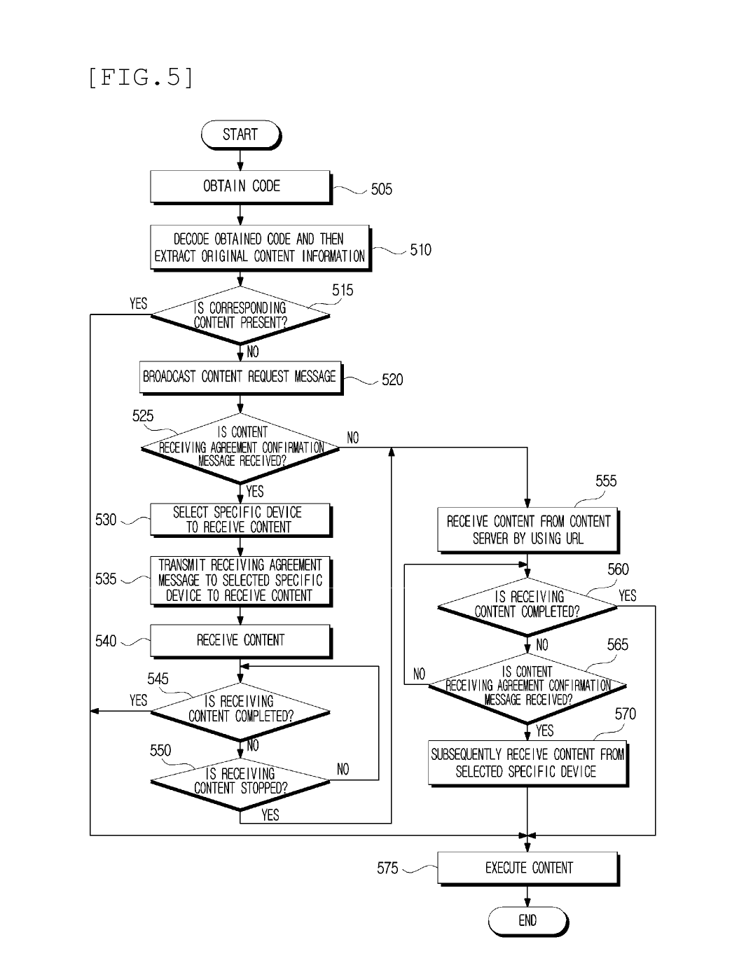

FIG. 5 is a flowchart illustrating an operation performed by a terminal in the method for mobile content advertising according to the embodiment of the present invention.

In FIG. 5, it is assumed that the first user terminal is the terminal that receives the content for convenience of description.

Referring to FIG. 5, the first user terminal obtains the code and provides the obtained code (step 505).

Herein, the first user terminal may include, for example, a portable terminal (for example, a smart phone, a PDA, or a PMP) incorporated with a camera, a PC connected with the camera, a camera incorporated tablet PC, a camera incorporated notebook, a goggle connected with the camera, and the like.

Further, the first user terminal includes a camera (not illustrated) that is capable of obtaining the code, and photographs the code by means of the provided camera and thereafter, provides the obtained code. Herein, it should be understood that the camera is presented as a representative example of all devices capable of optically recognizing the code.

The first user terminal extracts original content information and URL information by decoding the code provided in step 505, and provides the extracted original content information and URL information (step 510).

The first user terminal judges whether the corresponding content is already stored by using the original content information extracted in step 510 (step 515) and when it is judged that the corresponding content is not stored, the first user terminal broadcasts the content request message inserted with the original content information obtained in step 510 by using a communication network (step 520).

After broadcasting the content request message in step 520, the first user terminal judges whether a plurality of content receiving agreement confirmation messages is received from at least one content providing means or at least one other terminal (step 525).

When the first user terminal judges that the plurality of content receiving agreement confirmation messages is obtained from at least one content providing means or at least one other terminal in step 525, the first user terminal extracts information on the content providing means or other user terminals from all of the content receiving agreement confirmation messages and selects a device, which will receive the content, based on a predetermined reference (step 530).

Herein, the predetermined reference may include, for example, the intensity, a transmission speed, and the like of a signal received from at least one content providing means or at least one other terminal.

The first user terminal transmits the content receiving agreement message to the device selected in step 530 by the unicast scheme (step 535).

The first user terminal transmits the content receiving agreement message in step 535 and thereafter, starts receiving the content from the device (step 540) and judges whether the content is completely received (step 545).

When the first user terminal judges that the content is not completely received in step 545, the first user terminal judges that receiving of the content is stopped (step 550) and when the first user terminal judges that receiving of the content is not stopped, the first user terminal continuously receives the content.

Herein, the case where receiving of the content is stopped may include, for example, when the terminal providing the content deviates from a radio transmission/reception range to move to other regions, when the first user terminal that receives the content deviates from the radio transmission/reception range to move to other regions, when the intensity of a radio transmission/reception signal is weak, and the like.

When the first user terminal does not obtain the content receiving agreement confirmation message from at least one content providing means or at least one other terminal in step 525 or when the first user terminal judges that receiving of the content is stopped in step 550, the first user terminal may subsequently receive the content by accessing the content server connected through the network by using the stored URL (step 555).

Herein, when the first user terminal judges that receiving of the content is stopped in step 550, the first user terminal accesses the content server by using the URL, transmits original index information, which corresponds to a location where or a time when the content will be subsequently received, to the content server by using original index information previously allocated to each content part, and thereafter, may receive the content subsequently from the part where receiving the content is stopped.

Thereafter, the first user terminal judges whether receiving of the content is completed (step 560) and when the first user terminal judges that receiving of the content is not completed, the first user terminal judges whether the content receiving agreement confirmation message is received from at least one content providing means or at least one other terminal (step 565).

When the first user terminal judges that the content receiving agreement confirmation message is not received from at least one other content providing means or at least one other terminal in step 565, the first user terminal continuously receives the received content by accessing the content server by using the URL.

However, when the first user terminal judges that the content receiving agreement confirmation message is received from at least one other content providing means or at least one other terminal in step 565, the first user terminal stops receiving the received content by accessing the content server by using the URL, and selects the device that will receive the content and receives the content subsequently from the part where receiving the content from the selected device is stopped (step 570).

Herein, since the original index is allocated to each content part, the first user terminal transmits the original index information, which corresponds to the location where or time when the content will be subsequently received, to the selected device and thereafter, may receive the content subsequently from the part where receiving the content is stopped.

Further, herein, the reason for stopping receiving the content from the content server and subsequently receiving the content by the selected device is that content receiving performance may be improved because a speed of receiving the content from the selected device is higher than a speed of receiving the content from the content server.

When the first user terminal judges that the corresponding content is present in step 515, the first user terminal executes the corresponding content according to the operation control signals provided when it is judged that receiving of the content is completed in steps 545 and 560, and when receiving of the content is completed through step 570 (step 575).

Herein, an operation control signal for indicating the obtained content may be provided when a user operates a key provided in the first user terminal and transmits the operation control signal to the first user terminal in response thereto.

In step 575, the first user terminal may include an audio and/or video codec corresponding to an encoded format in order to execute an adverting music, an advertising moving picture, a document, and the like which are encoded to a predetermined format and provide a video and/or audio signal corresponding to the executed content to a display device and/or an audio device.

In the method for mobile content advertising according to the embodiment of the present invention, which is illustrated in FIG. 5, the first user terminal requests the content and receives the requested content as an example, but in another embodiment of the present invention, when the first user terminal receives a content request message for a previously received content, the first user terminal may transmit a content corresponding to the content request message to a terminal that transmits the content request message. Further, in yet another embodiment of the present invention, according to any one of a user selection and a user's change of set-up of the first user terminal, when the first user terminal receives the content request message for the previously received content, the first user terminal may transmit the content corresponding to the content request message to the terminal that transmits the content request message.

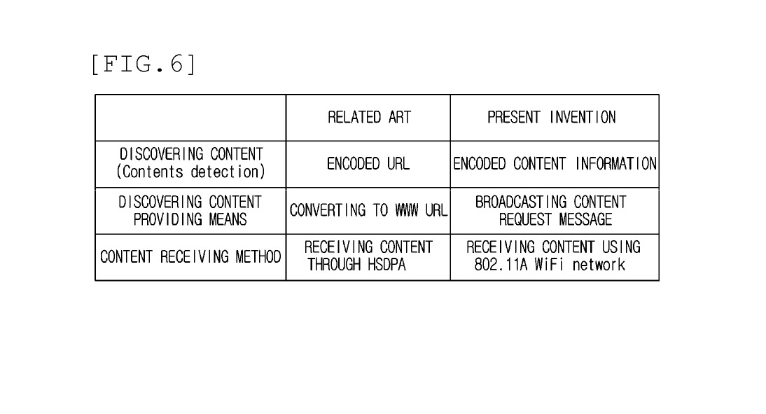

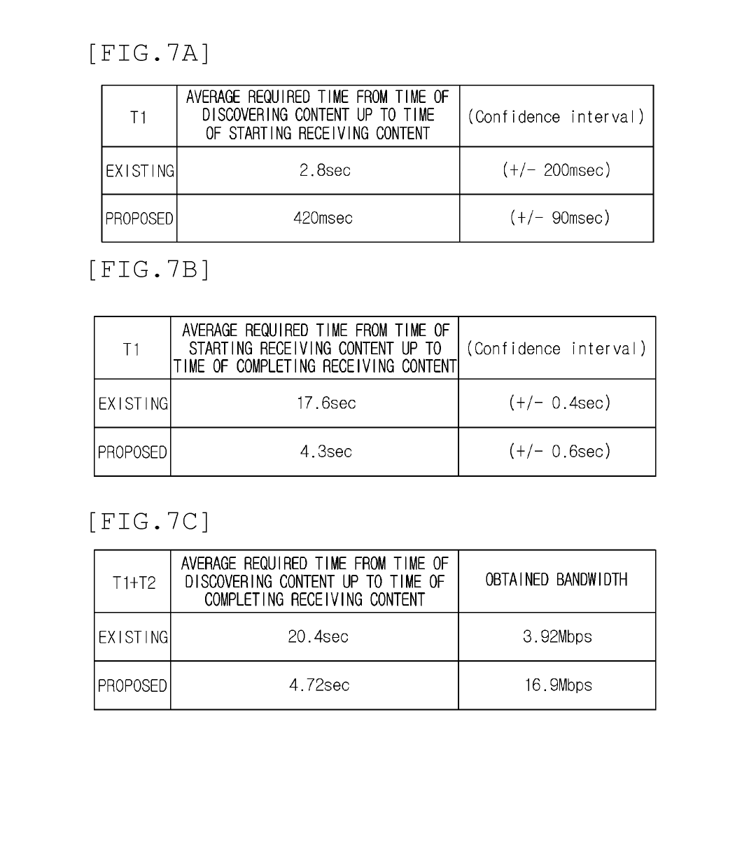

FIG. 6 illustrates an experimental environment for evaluating performance of the method for mobile content advertising according to the embodiment of the present invention. FIGS. 7A to 7C illustrate results of evaluating performance of the method for mobile content advertising according to the embodiment of the present invention. Referring to FIG. 6, in evaluating the performance of the method for mobile content advertising according to the embodiment of the present invention, the performances of an advertising method in the related art and the method for mobile content advertising according to the embodiment of the present invention are compared with each other with respect to a method of discovering the content, discovering the content providing means, and receiving the content for a content obtained by combining an advertising file having a size of 10 Mbytes and a coupon.

In detail, in the advertising method in the related art, an experimental environment is constructed by discovering the content and the content providing means by using the encoded URL and receiving the corresponding content through high speed downlink packet access (HSDPA).

In the method for mobile content advertising according to the embodiment of the present invention, the content is discovered by displaying the encoded content. Further, when the content providing means broadcasts the content request and obtains the content receiving agreement confirmation message, the content providing means that will receive the corresponding content is discovered and selected by deciding the content providing means. The experimental environment is constructed by receiving the corresponding content through an 802.11a WiFi (wireless lan).

Further, each of the advertising method in the related art and the method for mobile content advertising according to the embodiment of the present invention is repeatedly experimented 50 times. An average value of a time required at the time of receiving the content and a confidence interval according to each method are measured during the 50 repeated experiments.

FIGS. 7A to 7C illustrate results of experimenting each of the advertising method in the related art and the method for mobile content advertising according to the embodiment of the present invention 50 times.

In detail, FIG. 7A illustrates a required time (discovery time, T1) from the time of discovering the content up to the time of starting receiving the content, FIG. 7B illustrates a required time (delivery time, T2) from the time of starting receiving the content up to the time of completing receiving the content, and FIG. 7C illustrates a required time (total downloading time, T1+T2) from the time of discovering the content up to the time of completing receiving the content.

By considering FIG. 7C which is a value obtained by adding up the required time (FIG. 7A) from the time of discovering the content up to the time of starting receiving the content and the required time (FIG. 7B) from the time of starting receiving the content up to the time of completing receiving the content, it can be seen that an average required time from the time of discovering the content up to the time of completing receiving the content is 20.4 seconds in the case of the advertising method in the related art and an average required time from the time of discovering the content up to the time of completing receiving the content is 4.72 seconds in the case of the method for mobile content advertising according to the embodiment of the present invention.

Therefore, when the method for advertising according to the embodiment of the present invention is used, a far shorter time is required from the time of discovering the content up to the time of completing receiving the content, thereby improving the qualities of advertising and promotion content services and improving the efficiency of advertising and promotion.

Although the present invention has been described with reference to the embodiments as above, it can be appreciated by those skilled in the art various modifications and changes of the present invention can be made within the scope without departing from the spirit and the area of the present invention disclosed in the appended claims.

1. A system for mobile content advertising, comprising:
a code creating means configured to create original content information and a code corresponding to content to be provided;
at least one content providing means configured to store the content and the original content information and transmit the corresponding content in response to a received content request message; and
a terminal configured to obtain a code, extract original content information corresponding to the obtained code, broadcast a content request message including the extracted original content information, and receive the corresponding content from the at least one content providing means or at least one other terminal.

2. The system for mobile content advertising of claim 1, wherein the code creating means includes:
a content information extracting unit configured to extract basic content information from the provided content, divide the provided content by a predetermined size or time unit, and allocate an original index to each of the divided content parts;
an original content information creating unit configured to create the original content information by applying a Hash function to the extracted basic content information; and
a code creating unit configured to create a code by using the created original content information.

3. The system for mobile content advertising of claim 2, wherein the basic content information includes at least one of a content publisher ID, a content size, a content name, a business type of the content publisher, a business condition of the content publisher, a type of a coupon, and a uniform resource locator (URL).

4. The system for mobile content advertising of claim 1, wherein the content providing means includes:
a content providing control unit configured to judge, when obtaining the content request message from the terminal, whether a content corresponding to the obtained content request message is present, transmit a content receiving agreement confirmation message to the terminal when the corresponding content is present, and perform control for transmitting the corresponding content when receiving a content receiving agreement message from the terminal;
a first content communication unit configured to perform communication with the terminal based on the control by the content providing control unit; and
a content managing unit configured to store the content provided from the code creating means and the original content information corresponding thereto.

5. The system for mobile content advertising of claim 1, wherein the terminal receives an advertising content from the at least one content providing means or at least one other terminal under a distributed environment, and receives a coupon from a content server by using a URL extracted from the obtained code.

6. The system for mobile content advertising of claim 1, wherein the terminal selects, when broadcasting the content request message including the extracted original content information and then obtaining a plurality of content receiving agreement confirmation messages from the at least one content providing means or the at least one other terminal, a device, which is to receive the content, of the at least one content providing means or the at least one other terminal based on a predetermined reference, transmits the content receiving agreement message to the selected device, and then receives the corresponding content from the device.

7. The system for mobile content advertising of claim 6, wherein the terminal selects, when receiving of the corresponding content is stopped during receiving the corresponding content from the device, another device that is able to subsequently receive the corresponding content and provides the selected another device with original index information corresponding to a location where or a time when the corresponding content is to be subsequently received to subsequently receive the corresponding content from the selected another device.

8. The system for mobile content advertising of claim 7, wherein the terminal provides the original index information corresponding to the location where or the time when the corresponding content is to be subsequently received by accessing the content server by using the URL extracted from the obtained code and then subsequently receives the corresponding content from the content server, when receiving of the corresponding content is stopped during receiving of the corresponding content from the device and there is no device that is to subsequently receive the corresponding content.

9. The system for mobile content advertising of claim 1, wherein the terminal receives the corresponding content by accessing the content server by using the URL extracted from the obtained code when the content receiving agreement confirmation message is not received within a predetermined time.

10. The system for mobile content advertising of claim 9, wherein the terminal stops receiving the corresponding content and selects a device, which is to receive the corresponding content, between at least one content providing means and at least one other terminal and then provides the selected device with the original index information corresponding to the location where or the time when the corresponding content is to be subsequently received to subsequently receive the corresponding content, when receiving the content receiving agreement confirmation message from the at least one content providing means or the at least one other terminal during receiving the corresponding content by accessing the content server by using the extracted URL.

11. The system for mobile content advertising of claim 1, wherein the terminal provides the content receiving agreement confirmation message to the at least one other terminal when receiving the content request message for a previously received content from the at least one other terminal and transmits, when receiving the content receiving agreement message from a specific terminal of the at least one other terminal, the previously received content to the specific terminal.

12. The system for mobile content advertising of claim 1, wherein the terminal provides the content receiving agreement confirmation message to the at least one other terminal when receiving the content request message for a previously received content from the at least one other terminal and transmits, when receiving the content receiving agreement message from a specific terminal of the at least one other terminal, the previously received content to the specific terminal, according to any one of a user's selection and a user's change of set-up of the terminal.

13. A method for mobile content advertising of an advertising system including a code creating means, at least one content providing means, a terminal, and at least one other terminal, the method comprising:
creating, by the code creating means, original content information and a code corresponding to content to be provided;
storing, by the at least one content providing means, the content and the original content information and transmitting the corresponding content to the terminal in response to a content request message received from the terminal; and
obtaining, by the terminal, a code, extracting original content information corresponding to the obtained code, broadcasting a content request message including the extracted original content information, and receiving the corresponding content from the at least one content providing means or the at least one other terminal.

14. The method for mobile content advertising of claim 13, wherein the creating of, by the code creating means, original content information and a code corresponding to content to be provided includes:
extracting, by the code creating means, basic content information from the provided content, dividing the provided content by a predetermined size or time unit, and allocating an original index to each of the divided content parts;
creating, by the code creating means, the original content information by applying a Hash function to the extracted basic content information; and
creating, by the code creating means, a code by using the created original content information.

15. The method for mobile content advertising of claim 14, wherein the basic content information includes at least one of a content publisher ID, a content size, a content name, a business type of the content publisher, a business condition of the content publisher, a type of a coupon, and a uniform resource locator (URL).

16. The method for mobile content advertising of claim 13, wherein the transmitting of the corresponding content in response to the received content request message includes:
judging, by the at least one content providing means, when obtaining the content request message from the terminal, whether a content corresponding to the obtained content request message is present and transmitting a content receiving agreement confirmation message to the terminal when the corresponding content is present; and
reading, by the at least one content providing means, a content corresponding to the content request message and transmitting the read content to the terminal when receiving a content receiving agreement message from the terminal.

17. The method for mobile content advertising of claim 13, wherein in the receiving of the corresponding content, the terminal receives an advertising content from the at least one content providing means or the at least one other terminal under a distributed environment, and receives a coupon by accessing a content server by using a URL extracted from the obtained code.

18. The method for mobile content advertising of claim 13, wherein the receiving of the corresponding content includes:
broadcasting, by the terminal, the content request message including the extracted original content information;
selecting, by the terminal, a device, which is to receive the corresponding content, of the at least one content providing means or the at least one other terminal, based on a predetermined reference, when obtaining a plurality of content receiving agreement confirmation messages from the at least one content providing means or the at least one other terminal; and
transmitting, by the terminal, the content receiving agreement message to the selected device to receive the corresponding content from the selected device.

19. The method for mobile content advertising of claim 18, wherein in the receiving of the corresponding content, when receiving of the corresponding content is stopped during receiving the corresponding content from the device, another device that is able to subsequently receive the corresponding content is selected and original index information corresponding to a location where or a time when the corresponding content is to be subsequently received is provided to the selected another device to subsequently receive the corresponding content from the selected another device.

20. The method for mobile content advertising of claim 19, wherein in the receiving of the corresponding content, the original index information corresponding to the location where or the time when the corresponding content is to be subsequently received is provided by accessing the content server by using the URL extracted from the obtained code and then the corresponding content is subsequently received from the content server, when receiving of the corresponding content is stopped during receiving the corresponding content from the device and there is no device that is to subsequently receive the corresponding content.

21. The method for mobile content advertising of claim 13, wherein in the receiving of the corresponding content, the terminal receives the corresponding content by accessing the content server by using the URL extracted from the obtained code when the content receiving agreement confirmation message is not received within a predetermined time.

22. The method for mobile content advertising of claim 21, wherein in the receiving of the corresponding content, the receiving of the corresponding content is stopped and the device that is to receive the corresponding content is selected between the at least one content providing means and the at least one other terminal and then the original index information corresponding to the location where or the time when the corresponding content is to be subsequently received is provided to the selected device to subsequently receive the corresponding content, when receiving the content receiving agreement confirmation message from the at least one content providing means or the at least one other terminal during receiving the corresponding content by accessing the content server by using the extracted URL.

23. The method for mobile content advertising of claim 13, wherein the receiving of the corresponding content includes providing the content receiving agreement confirmation message to the at least one other terminal when receiving the content request message for a previously received content from the at least one other terminal and transmitting, when receiving the content receiving agreement message from a specific terminal of the at least one other terminal, the previously received content to the specific terminal.

24. The method for mobile content advertising of claim 13, wherein the receiving of the corresponding content includes providing the content receiving agreement confirmation message to the at least one other terminal when receiving the content request message for a previously received content from the at least one other terminal and transmitting, when receiving the content receiving agreement message from a specific terminal of the at least one other terminal, the previously received content to the specific terminal, according to any one of a user's selection and a user's change of set-up of the terminal.
